(19) United States
(12) Patent Application Publication
(10) Pub. No.: US 2013/0092075 A1
(43) Pub. Date: Apr. 18, 2013

(54) DIGITAL METER

(71) Applicants: Christopher J. Volpe, Waterford, MI (US); Arthur S. Brown, Sterling Heights, MI (US)

(72) Inventors: Christopher J. Volpe, Waterford, MI (US); Arthur S. Brown, Sterling Heights, MI (US)

(21) Appl. No.: 13/272,539

(22) Filed: Oct. 13, 2011

(51) Int. Cl. G01D 11/28

(52) U.S. Cl. 116/201; 116/286

(57) ABSTRACT

An instrument cluster assembly includes a plurality of gauges that each provides an indication and measure for communicating vehicle operating conditions to a vehicle operator. At least one of the gauges includes a secondary scale that includes a plurality of individually illuminatable segments. The measured parameter is indicated by the secondary scales by illuminating select segments in a variable manner between a fully illuminated, partially illuminated and off conditions to provide an additional degree of precision.

### BACKGROUND

This disclosure generally relates to gauge communicating information regarding a vehicle operating parameter. More particularly, this disclosure relates to a gauge that includes a variable scale that utilizes different levels of illumination to illustrate a measured vehicle parameter.

Operating parameters are communicated to a vehicle operator using dial gauges, digital gauges, lights and panels. In each instance, the goal is to communicate vehicle information in a useful manner with a required degree of precision. The level of precision and importance of the information dictates what type of gauge will be utilized. In some instances the precise level of a value is not needed, just that the measured values are within some desired range of acceptable operating parameters. Other gauges, such as the speedometer or tachometer are desired to provide accurate values throughout the entire operating range. One example type of scale utilizes a plurality of lights that are selectively lit to communicate a measured parameter. Disadvantageously, the use of lights limits the precision available as typically a light is either on or off and therefore may provide limited levels of precision.

### SUMMARY

A disclosed instrument cluster assembly includes a plurality of gauges that each communicate vehicle operating conditions to a vehicle operator. At least one of the gauges includes a secondary scale that includes a plurality of individually illuminatable segments. A measured parameter is indicated on the secondary scales by illuminating select segments in a variable manner between a fully illuminated, partially illuminated and off condition to provide desired degree of precision.

These and other features disclosed herein can be best understood from the following specification and drawings, the following of which is a brief description.

### BRIEF DESCRIPTION OF THE DRAWINGS

FIG. 1 is a front view of an example instrument cluster.

FIG. 2 is an enlarged view of an example gauge.

FIG. 3 is another enlarged view of the example gauge.

FIG. 4 is an enlarged view of a portion of the example gauge.

### DETAILED DESCRIPTION

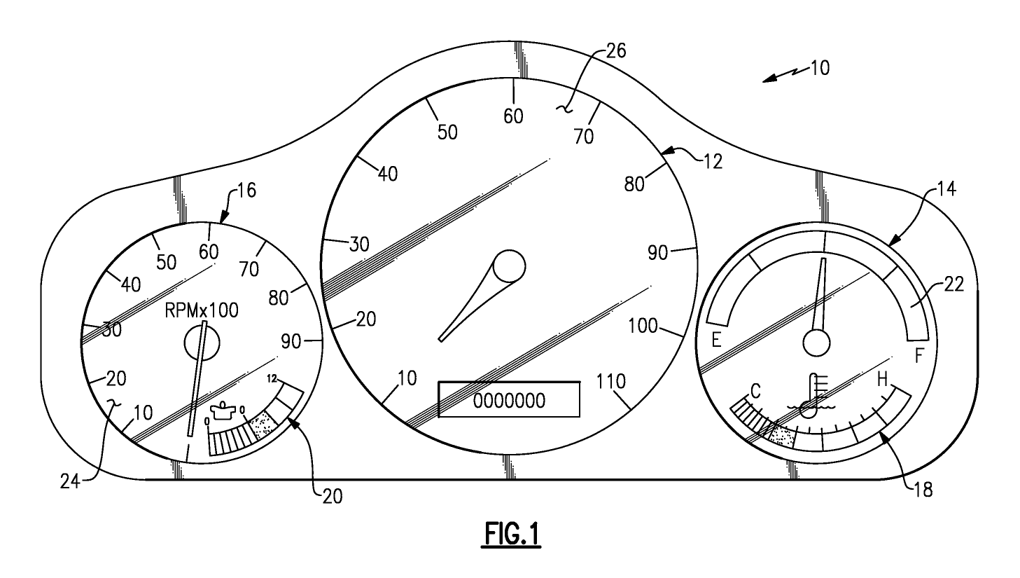

Referring to FIG. 1, an instrument cluster assembly 10 includes a plurality of gauges 12, 14, 16 that each provide an indication and measure of a vehicle operating condition to a vehicle operator. The example instrument cluster assembly 10 includes a main gauge 12 that includes scale 26 that indicates the speed of the vehicle. The gauge 14 includes a scale 22 that indicates a fuel level and a secondary scale 18 that provides an indication of water coolant temperature. The gauge 16 includes scale 24 that provides information indicative of engine rpm and a secondary scale 20 that provides a measure of oil pressure. The secondary scales 18, 20 indicate the measured parameter by illuminating select increments in a variable manner to provide an additional degree of precision.

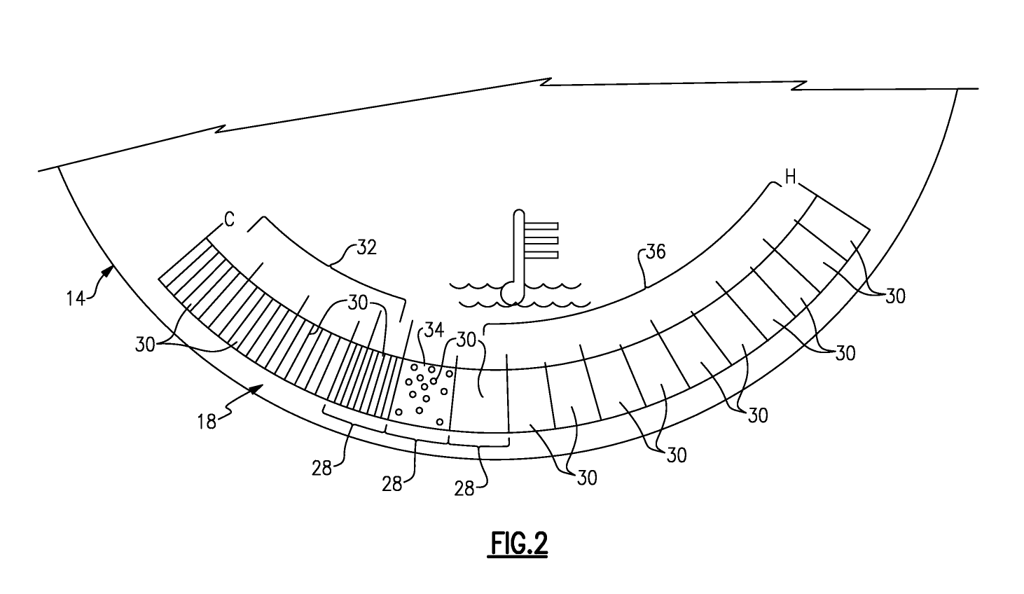

Referring to FIG. 2, the example scale 18 includes a plurality of segments 30 that represent a single increment 28 of the measurement represented by the scale 18. In this example each increment is a temperature division between a cold and hot condition. In other scales each increment may represent a fixed number of pressure units such as bars or PSI. Moreover, each increment could relate to any desired measurement represented by the scale. Each of the increments 28 are selectively illuminated between a fully illuminated condition, a partially illuminated condition and an off condition. This variable illumination provides an increased level of precision for the example secondary scale 18.

In this example the scale 18 is an indication of coolant temperature. The scale is illuminable to indicate a cold condition indicated by the letter C to a hot condition indicated by the letter H. Each of the plurality of segments 30 are individually illuminable to indicate a measure on the scale 18. In this example the segments that are indicated by the reference number 32 are in a fully illuminated condition. A partially illuminated segment 34 indicates that the level of measure of temperature has not reached a level that is a full increment of the measure provided by scale 18. In other words, the partially illuminated segment 34 indicates that the water temperature in this example has not reached a level such that the accompanying segment would be fully illuminated. For example, if each increment represents 10 degrees of temperature change, the partially illuminated segment 34 would indicate a temperature change of between 5 and 10 degrees. Further, a plurality of segments 36 are in a non-illuminated condition and indicate that the water temperature has not reached a level or increment that would represented by illumination of those segments.

Variable illumination of each of the segments provides an increased precision to the secondary gauges 18 that is otherwise not provided by simply alternating each of the segments between a fully on condition and a fully off condition. This added level of precision can be utilized to provide an added measure of accuracy to the scale 18.

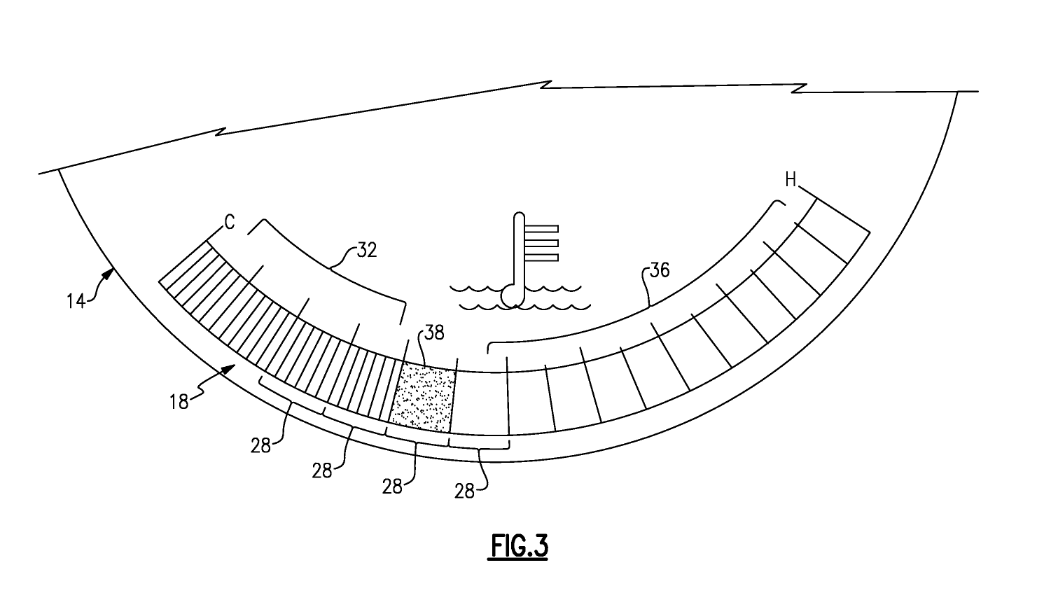

Referring to FIG. 3, the example scale 18 is shown with the same plurality of segments 32 in a fully illuminated condition. The partially illuminated segment indicated by 38 is illuminated in a second partially illuminated condition. As appreciated, a variable illumination is included for the scale 18 at varying degrees of illumination that can be utilized to provide added degrees of precision. In this example, another level of partial illumination is indicated by the shaded of the segment 38. This added level of accuracy further enhances the operation and communication of information indicative of vehicle operations provided by the scale 18. In this example, the second level of illumination represented by segment 38 is brighter than the partial illumination indicated in FIG. 2 by segment 34, but not as bright as a fully illuminated segment represented by segments 32.

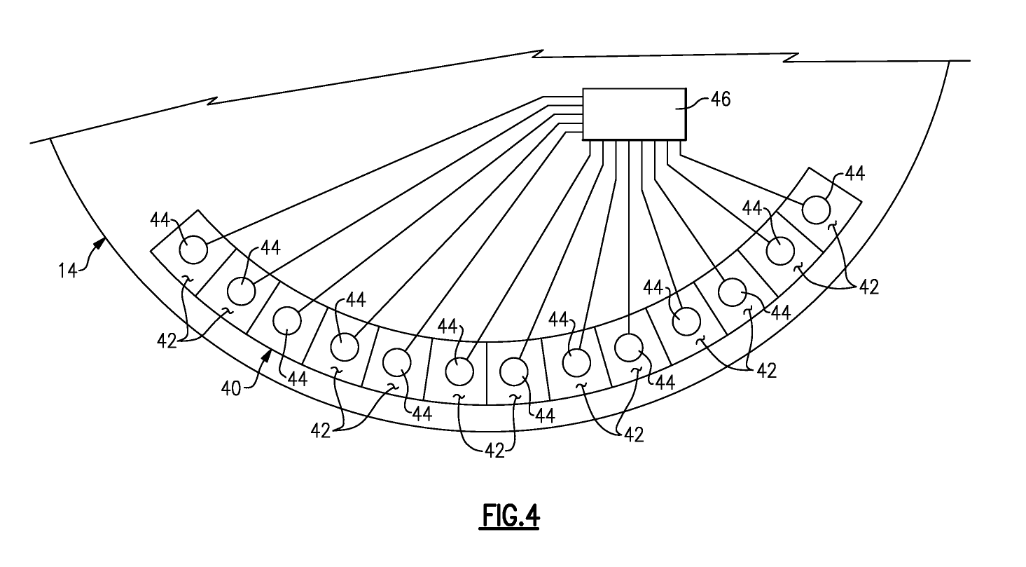

Referring to FIG. 4, a section view is illustrated of the scale 18. This view is provided without a face plate that would normally cover the plurality of lights. In this example, each of the plurality of lights 44 are each enclosed within a light housing 40 that defines a plurality of separate chambers 42. Each of the chambers 42 includes a single light source 44. Each of the light sources 44 is illuminatable between a fully on condition, a fully off condition and several partial illuminated conditions. The partial illuminated condition can include an intensity that varies from 0 to 100%. Moreover, the intensity of each partial illuminated condition could include a finite increment of light intensity or may also include a continuously variable intensity. Each of the separate light sources 34 are controlled by a controller 46. The example controller 46 is shown within the gauge 14 however the controller 46 may be part of a larger controller that controls the entire instrument control assembly. Moreover, the controller 46 may be part of a complete vehicle control that controls the entire vehicle. In this example, each of the light sources 44 comprises a light emitting diode LED. However, the light could come from more than one light source disposed within a common chamber 42. Each of the light sources 44 is housed within a separate light chamber such that light from one light source 44 would not spill into an adjacent chamber 42.

In addition to the varying degrees of partial illumination the example scale 14 could be illuminated with different colors to indicate the varying levels of measured value provided by the scale 18. For example, each of the light sources 44 may be illuminated in a first color such as yellow which would turn to green once the measured value attained a value that warranted full illumination that indicated a full increment on the scale 18.

The provision of partial illumination of each of the increments allows for each of the increments to communicate an added level of precision for the simple gauge 18. This added level of precision is accomplished without additional structure and can be instituted with minimal changes to the entire instrument cluster assembly. Accordingly, the example instrument cluster assembly includes gauges that utilize partial illumination to increase a precision and indicate that a measured value has only partially attained a value indicated by the entire increment of the scale 18.

Although an example embodiment has been disclosed, a worker of ordinary skill in this art would recognize that certain modifications would come within the scope of this disclosure. For that reason, the following claims should be studied to determine the scope and content of this invention.

What is claimed is:

1. A gauge for a vehicle comprising:
a scale representing a vehicle operating parameter, the scale having a plurality of discrete sections representing a single increment of a measured vehicle operating parameter; and
a separate individual light source associated with each of the plurality of discrete sections, wherein each of the light sources are illuminatable according to one of a fully illuminated condition, a partially illuminated condition and a non-illuminated condition.

2. The gauge as recited in claim 1, wherein each of the plurality of discrete sections represents a portion of the single increment of the measured vehicle operating parameter when the single light source associated with that discrete section is in the partially illuminated condition.

3. The gauge as recited in claim 1, wherein each of the plurality of discrete sections represents a full increment of the measured vehicle operating parameter when the single light source associated with that discrete section is in the fully illuminated condition.

4. The gauge as recited in claim 1, wherein a discrete section illuminated according to the partially illuminated condition is preceded by a discrete section illuminated according to the fully illuminated condition and is followed by a discrete section illuminated according to the non-illuminated condition.

5. The gauge as recited in claim 1, including a light housing defining a plurality of separate light chambers corresponding with the plurality of discrete sections, each of the plurality of separate light chambers including one of the individual light sources.

6. The gauge as recited in claim 1, including a controller for governing illumination of each of the light sources.

7. The gauge as recited in claim 1, wherein the scale represents a measured temperature of a fluid.

8. The gauge as recited in claim 1, wherein the scale represents a measured pressure of a fluid.

9. The gauge as recited in claim 1, wherein the scale represents a measured speed of the vehicle.

10. The gauge as recited in claim 1, wherein each of the light sources are of a common color.

11. The gauge as recited in claim 1, wherein at least two of the light sources are of different colors.

12. A vehicle instrument cluster assembly comprising:
at least one gauge including a scale representing a vehicle operating parameter, the scale having a plurality of discrete sections representing a single increment of a measured vehicle operating parameter; and
a separate individual light source associated with each of the plurality of discrete sections, wherein each of the light sources are illuminatable according to one of a fully illuminated condition, a partially illuminated condition and a non-illuminated condition.

13. The vehicle instrument cluster assembly as recited in claim 12, wherein each of the plurality of discrete sections represents a portion of the single increment of the measured vehicle operating parameter when the single light source associated with that discrete section is in the partially illuminated condition.

14. The vehicle instrument cluster assembly as recited in claim 12, wherein each of the plurality of discrete sections represents a full increment of the measured vehicle operating parameter when the single light source associated with that discrete section is in the fully illuminated condition.

15. The vehicle instrument cluster assembly as recited in claim 12, wherein a discrete section illuminated according to the partially illuminated condition is preceded by a discrete section illuminated according to the fully illuminated condition and is followed by a discrete section illuminated according to the non-illuminated condition.

16. The vehicle instrument cluster assembly as recited in claim 12, including a controller for governing illumination of each of the light sources.

17. A method of indicating a measured value indicative of a vehicle operating condition, the method comprising the steps of:
defining a scale to have a plurality of discrete sections;
associating an increment of a measured valued with each of the plurality of discrete sections;
illuminating a light source associated with one of the plurality of discrete sections in a partially illuminated condition to indicate a portion of an increment of the measured value; and
illuminating a light source associated with one of the plurality of discrete sections in a fully illuminated condition to indicate an increment of the measured value.

18. The method as recited in claim 17, including changing the light source from a partially illuminated condition to a fully illuminated condition responsive to the measured value changing a full increment of the measured value.

19. The method as recited in claim 17, including the step of changing the light source from the fully illuminated condition to a partially illuminated condition responsive to the measured value changing less than a full increment of the measured value.
